(19) United States
(12) Patent Application Publication
(10) Pub. No.: US 2004/0213660 A1
(43) Pub. Date: Oct. 28, 2004

(54) Automatic transport system

(76) Inventors: Dish Dai, Hsinchu (TW); Casper Huang, Tainan Hsinchu (TW); Chien-Liang Lin, Tainan Hsinchu (TW); Kenny Lin, Kaohsiung (TW)

Correspondence Address: J.C. Patents, Suite 250, 4 Venture, Irvine, CA, 92618, US

(21) Appl. No.: 10/814,688

(22) Filed: Mar. 30, 2004

(30) Foreign Application Priority Data
Apr. 10, 2003 (TW) 92108202

(51) Int. Cl. B65G 1/00

(52) U.S. Cl. 414/800

(57) ABSTRACT

An automatic transport system having a plurality of stocking centers and a circular transport rail for transporting material items between the centers. The stocking centers are enclosed within the circular transport rail having. Both ends of all stocking centers are close to the circular transport rail and the circular transport rail moves in a fixed direction.

### CROSS-REFERENCE TO RELATED APPLICATION

This application claims the priority benefit of Taiwan application serial no. 92108202, filed on Apr. 10, 2003.

### BACKGROUND OF THE INVENTION

1. Field of Invention

The present invention relates to a transport system inside a semiconductor manufacturing facility. More particularly, the present invention relates to an automatic transport system.

2. Description of Related Art

The selection of a suitable transport system for front end manufacturing inside a semiconductor plant is time-consuming. The transport system must be considered together with the layout of the building early on before initiating on-site construction. In fact, the transport system is related to many other engineering aspects including building structure, clean room facility, transport cost, computer linkage, damage control and earthquake prevention.

In general, the transport system of most semiconductor plant can be roughly divided into three major sections: a front end section for producing semiconductor wafers; a back end section for packaging and assembling semiconductor chips; and a stocking center for holding finished or semi-finished products.

Major properties of the transport system required in the front-end section include: a high degree of cleanliness inside the clean room, all day working capacity, high reliability, sufficient transport capacity, suitable electrostatic and electromagnetic screening, tolerance for constant acceleration-deceleration and vibration, a high degree of safety in operation, provision of a computer interface linking manufacturer and consumer and flexibility in any subsequent plant modification. The type of front-end transport system can also be categorized according to service into three major categories, namely, inter-bay transport, intra-bay transport and inter-floor transport.

Conventional inter-bay transport system mainly includes a plurality of stocking centers and conveyor rails linking up various stocking centers. The stocking centers are temporary storage places for holding chips waiting for an operation by a processing station or chips waiting for a transfer to other manufacturing facilities. The stocking centers also serve as junctions in intra-bay transport system. In general, a stocking system comprises of material racks, rack masters, conveyor ports, cleanway ports and a stock management system.

Most automatic transport systems belong to either a ball room design or a fish-fin layout. For a stocking system, a parallel design having a distribution as shown in FIG. 1 is often used.

FIG. 1 is a top view of a conventional single-rail automatic transport system. As shown in FIG. 1, a conventional single-rail transport system includes stocking centers 1-10 and a rail 102 linking up various stocking centers. The stocking centers 1-10 are distributed in the interior of the circular rail 102. The stocking system employs a parallel design. In other words, the stocking centers 1-10 are positioned in parallel along each longitudinal side and close to the circular rail 102. Direction of movement 104 for items on the rail 102 is generally fixed.

To transport a material item from a first area 110 to a second area 112, the material item must follow the designated direction 114 traversing half of the circular rail 102 by loading the item at stocking center 7 and unloading the item from stocking center 3. Similarly, to transport a material item from the first area 110 to a third area 116, the material item must follow the designated direction 118 traversing almost the entire circular rail 102 by loading the item at stocking center 7 and unloading the item from stocking center 9.

Thus, one major drawback of the single-rail automatic transport system is the long travel distance from source to destination that may lead to considerable delay and traffic slow down. Consequently, a double-rail transport system like the one shown in FIG. 2 is often employed.

FIG. 2 is a top view of a conventional double-rail automatic transport system. As shown in FIG. 2, the double-rail transport system includes stocking centers 1-10 and a pair of transport rails 202 and 204 for transporting items between various centers. The circular rail 204 is positioned inside the circular rail 202. The stocking centers 1-10 are located between the inner rail 204 and the outer rail 202. The stocking centers follow a parallel design. In other words, the stocking centers 1-10 are equally distributed on each side of a longitudinal axis of the rails such that one side of the stocking centers is closer to the rail 202 and the other side of the stocking centers is closer to the rail 204. To facilitate the transport of material items, the rail 202 moves in a first direction 206 while the other rail 204 moves in an opposite direction 208.

To transport a material item from a first area 210 to a second area 212, the material item must follow the designated direction 214 traversing half of the circular rail 202 by loading the item at stocking center 7 and unloading the item from stocking center 3. Similarly, to transport a material item from the first area 210 to a third area 216, the material item must follow the designated direction 218 by loading the item at stocking center 7 and unloading the item from stocking center 9.

The aforementioned double-rail transport system is indeed capable of shortening transport distance and reducing transport time. However, the addition of one more transport rail not only increases construction cost; maintenance cost is increased as well.

### SUMMARY OF THE INVENTION

Accordingly, one object of the present invention is to provide an automatic transport system capable of reducing material transport distance.

A second object of this invention is to provide an automatic transport system capable of reducing material transport time.

A third object of this invention is to provide an automatic transport system capable of increasing transport efficiency.

A fourth object of this invention is to provide an automatic transport system capable of speeding up material transport without setting up an additional rail. Hence, construction cost is reduced.

A fifth object of this invention is to provide an automatic transport system capable of increasing transport capacity.

To achieve these and other advantages and in accordance with the purpose of the invention, as embodied and broadly described herein, the invention provides an automatic transport system. The transport system includes a plurality of stocking centers and a circular transport rail for transporting material items between various stocking centers. The stocking centers are set up inside the circular transport rail. The stocking centers employ a perpendicular design. In other words, the longitudinal axis of the circular transport ring is perpendicular to the longitudinal axis of various stocking centers. Hence, both ends of each stocking center are close to the circular ring. The circular transport rail moves in a fixed direction.

This invention also provides a transporting method for an automatic transport system capable of transporting material items from a first area to a second area. The automatic transport system includes a circular transport rail and a plurality of stocking centers inside the circular rail. The circular transport rail is close to both ends of each stocking center. The transportation of material items follows a route from a first stocking center nearest the first area to a second stocking center nearest the second area. The transporting process includes loading the material item from the first area to one end of the stocking center nearest the first area and then loading the material item from the end of the stocking center closest to the first area to the circular transport rail. Thereafter, the circular rail transports the item to a second stocking center closest to the second area. Finally, the item is unloaded from the end of the second stocking center closest to the second area to the second area.

Assuming that the probability of items being transported to each of the stocking centers is identical, the longest distance traveled by a material item for a conventional single-rail transport system having a parallel design is about one circular round while the shortest distance is 0. Hence, the travel distance of each item is on average 0.5 circular round. Similarly, the longest distance traveled by a material item for a conventional double-rail transport system having a parallel design is about half a circular round while the shortest distance is 0. Hence, the travel distance of each item is on average 0.25 circular round. With the automatic transport system of this invention having a single-rail perpendicular design, the longest travel distance of each item is still 0.5 circular round and the shortest travel distance is still 0. However, the longest distance of travel only occurs when the items are transported from a stocking center at one end to a stocking center at the other end. Hence, the average distance traveled by each material item is only 0.14 circular round.

One major advantage of this invention is the incorporation of a perpendicular stocking center design with a circular transport rail. Transport distance of items in the circular transport rail is on average just half that of a conventional double-rail transport system. Hence, transport time is almost cut by half. With a reduction in transport time, transport capacity is doubled and transport efficiency is increased. In addition, installation and maintenance cost is only half as much as a conventional double-rail system.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a conventional single-rail automatic transport system.

FIG. 2 is a top view of a conventional double-rail automatic transport system.

FIG. 3 is a top view of an automatic transport system according to one preferred embodiment of this invention.

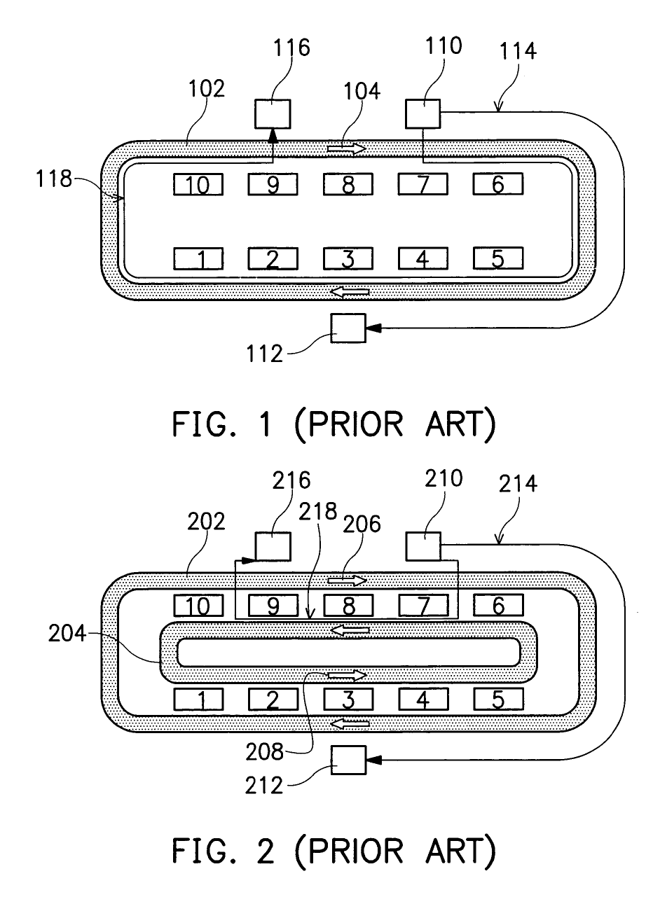

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

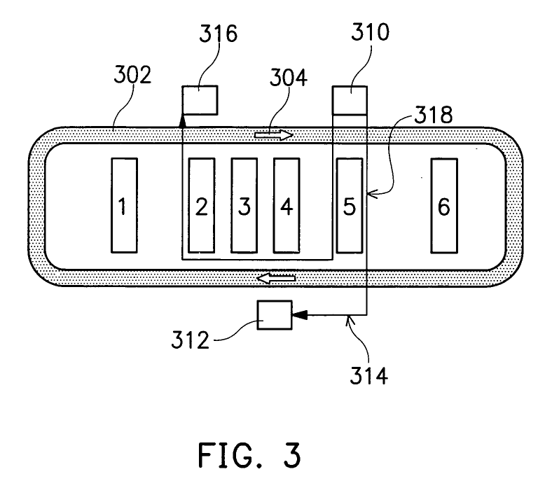

FIG. 3 is a top view of an automatic transport system according to one preferred embodiment of this invention. As shown in FIG. 3, the automatic transport system includes a plurality of stocking centers 1-6 and a circular transport rail 302 linking various stocking centers. The stocking centers 1-6 are enclosed inside the circular transport rail 302. The stocking centers have a perpendicular layout design. In other words, the longitudinal axes of the stocking centers 1-6 are all perpendicular to the longitudinal axis of the circular transport rail 302 so that both ends of each stocking centers are adjacent to the rail 302. In addition, the circular transport rail 302 may also be a track having vehicles thereon for transporting particular items.

To transport a material item from a first area 310 to a second area 312, the material item must follow the designated direction 314. The item is unloaded from the first area 310 to one end of the stocking center 5. The item is moved to the other end of the stocking center 5 and then unloaded from stocking center 5 to the circular transport rail 302. After moving together with the transport rail 302 for a short distance, the item is unloaded from the transport rail 302 to the stocking center 3. Finally, the item is unloaded from the stocking center 3 to the second area 312. Similarly, to transport a material item from the first area 310 to a third area 316, the material item must follow the designated direction 318. The item is unloaded from the first area 310 to one end of the stocking center 5. The item is moved to the other end of the stocking center 5 and then the item is unloaded from stocking center 5 to the circular transport rail 302. After moving together with the transport rail 302 for a short distance, the item is unloaded from the transport rail 302 to one end of the stocking center 2. The item is moved to the other end of the stocking center 2. Finally, the item is unloaded from the stocking center 2 to the third area 316.

Assuming that the probability of items transported to each of the stocking centers is identical, the longest distance traveled by a material item for a conventional single-rail transport system having a parallel design is about one circular round while the shortest distance is 0. Hence, the travel distance of each item is on average 0.5 circular round. Similarly, the longest distance traveled by a material item for a conventional double-rail transport system having a parallel design is about half a circular round while the shortest distance is 0. Hence, the travel distance of each item is on average 0.25 circular round. With the automatic transport system of this invention having a single-rail perpendicular design, the longest travel distance of each item is still 0.5 circular round and the shortest travel distance is still 0. However, the longest distance of travel only occurs when the items are transported from a stocking center at one end to a stocking center at the other end. Hence, the average distance traveled by each material item is only 0.14 circular round.

The transport distance of an item along the circular transport rail is only half that of a conventional double-rail transport system. Hence, transport time is cut in half and corresponding transport efficiency is increased. In addition, only one circular transport rail is required. Hence, installation and maintenance cost of rail is reduced compared with a conventional double-rail system.

In summary, major aspects of this invention include:

1. This invention incorporates a perpendicular stocking center design with a circular transport rail. Transport distance of items along the circular transport rail is greatly reduced.

2. On average, transport distance of items along the circular transport rail is just half that of a conventional double-rail transport system. Hence, transport time is only half as much.

3. With a reduction in transport time, transport capacity is doubled.

4. Similarly, with a reduction in transport time, transport efficiency is increased.

5. Installation and maintenance cost are only half as much as for a conventional double-rail system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An automatic transport system, comprising:
a circular transport rail; and
a plurality of stocking centers enclosed by the circular transport rail, wherein both ends of all the stocking centers are close to the circular transport rail.

2. The automatic transport system of claim 1, wherein the circular transport rail includes a track having a vehicle thereon for holding material items.

3. A method of transporting a material item from a first area to a second area using an automatic transport system having a circular transport rail and a plurality of stocking centers enclosed inside the rail, wherein both ends of all stocking centers are close to the circular transport rail, and the material item follows a transport route from a first stocking center closest to the first area to a second stocking center nearest to the second area, the method comprising:
unloading the material item from the first area to an end of the first stocking center closest to the first area;
unloading the material item from the first stocking center on the end closest to the first area to the circular transport rail;
transporting the material item to an end of a second stocking center nearest the second area; and
unloading the material item from the end of the second stocking center closet to the second area to the second area.
